(19) United States
(12) Patent Application Publication
(10) Pub. No.: US 2025/0285123 A1
(43) Pub. Date: Sep. 11, 2025

(54) IDENTIFICATION AND CALCULATION OF FINANCIAL LOSS FROM ODOMETER FRAUD

(71) Applicant: Howard Gene Nusbaum, Stamford, CT (US)

(72) Inventor: Howard Gene Nusbaum, Stamford, CT (US)

(21) Appl. No.: 19/069,880

(22) Filed: Mar. 4, 2025

Related U.S. Application Data
(60) Provisional application No. 63/630,009, filed on Mar. 5, 2024.
(60) Provisional application No. 63/719,786, filed on Nov. 13, 2024.

(51) Int. Cl. G06Q 30/018; G06Q 30/0201

(52) U.S. Cl. CPC G06Q 30/0185; G06Q 30/0206

(57) ABSTRACT

The disclosed subject matter relates to a system and method for identifying and computing financial loss incurred from odometer fraud. For example, the system and method disclosed herein includes an algorithm for detecting and quantifying financial harm by determining discrete data sets of vehicles for analysis, and applying applicable weighting criteria.

### CROSS-REFERENCE TO RELATED APPLICATIONS

This application claims the benefit of priority under 35 USC 119 to U.S. Provisional Application No. 63/719,786, filed on Nov. 13, 2024, and U.S. Provisional Application No. 63/630,009, filed on Mar. 5, 2024. The entire contents of each are hereby incorporated by reference.

### BACKGROUND OF THE DISCLOSED SUBJECT MATTER

### Field of the Disclosed Subject Matter

The disclosed subject matter relates to a system and method for identifying and computing financial loss incurred from odometer fraud. For example, the system and method disclosed herein includes an algorithm for detecting and quantifying financial harm by determining discrete data sets of vehicles for analysis, and applying applicable weighting criteria.

### Description of Related Art

It is recognized that odometer rollback fraud is widely acknowledged as a prevalent form of fraud perpetuated against consumers. Effective odometer disclosure systems can be essential for protecting consumers from odometer fraud and as a matter of public policy odometer fraud should be reduced or eliminated to the greatest extent possible.

As a result of the most current update to the Federal Odometer Act, federal law requires that for a vehicle older than 2010 and that is less than 10 years old and weighs less than 16,000 Gross Vehicle Weight, or conversely is a 2010 model or newer and is less than 20 years old and is less than 16,000 Gross Vehicle Weight, the seller is required to complete and issue an odometer disclosure at the time of sale to a buyer. In an odometer disclosure, the seller is required to make a declaration on the federal odometer disclosure statement based upon his or her knowledge of the odometer reading. The odometer disclosure statement is located on the title document. States also require completion of the odometer disclosure statement.

The odometer disclosure can be used to determine a vehicle's condition and value. In the absence of a detailed exhaustive inspection of a vehicle, the primary indicator of a vehicle's remaining life is its mileage. For most internal combustion engine (ICE) vehicles, and absent a prior accident and with regular maintenance, the average new vehicle is normally anticipated by the general public to last up to about 150,000 miles. For some makes and models of vehicles, that expectation can be higher, and for others it can be lower. For example, SUVs from makes such as Lexus are expected by the public to last closer to 200,000 miles. However, many smaller vehicles, and vehicles in general from lower quality brands may be generally anticipated by potential buyers to last closer to 100,000 miles. For any given make and model of a vehicle that is represented as being in good condition, the declared odometer mileage subtracted from the potential buyers' general expectation of full useful lifetime of a new vehicle is the basis for the buyer's expectation of the remaining life of the vehicle. When presented with a vehicle of higher mileage, especially 125,000 miles or higher, the total lifetime mileage expectation of that vehicle by a potential buyer may increase slightly from their normal assumptions for a typical vehicle of that make, however, their overall assumptions of remaining service life for that high mileage vehicle can narrow considerably. For any specific make and model, the current mileage is considered a more important indicator of remaining life than is the year model of the vehicle. For electric vehicles (EV), the same understanding has not yet been fully established in the public's mind. Due to a lack of confidence in mileage as a metric for estimating the remaining life of an EV vehicle, the resale market for EV vehicles faces uncertainty for buyers. It can produce lower sales and lower residual values for EV versions of the same makes of cars as for ICE versions of the same vehicles.

A buyer may rely upon the disclosed mileage of the vehicle to estimate the remaining useful vehicle life. When the odometer value is suspect or unknown, it can undermine a potential buyer's ability to reasonably estimate the vehicle's remaining useful life and can impact the vehicle's resale values. In particular, odometer tampering can impact the valuation of used vehicles and commercial transactions between buyers and sellers within the used vehicle market which can cause financial harm to a consumer. Hence, there is a need for methods and systems to determine financial loss incurred on a vehicle due to odometer fraud.

### SUMMARY OF THE DISCLOSED SUBJECT MATTER

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter includes a non-transitory computer readable medium with instructions stored thereon, that when executed by a processor, perform the steps of: providing a detailed damage assessment of a vehicle including a price of the vehicle paid by a buyer at a time of purchase of the vehicle and a fraudulent odometer mileage; determining an anticipated remaining lifetime mileage of the vehicle at the time of purchase of the vehicle based on the fraudulent odometer mileage and a maximum anticipated final lifetime mileage; determining a dollar residual remaining usage value available at the time of purchase of the vehicle based on the anticipated remaining lifetime mileage of the vehicles and a true remaining lifetime mileage at the time of purchase of the vehicle, the true remaining lifetime mileage based on a true mileage of the vehicle and the maximum anticipated final lifetime mileage; and determining total financial loss based on the dollar residual remaining usage value and the price of the vehicle paid by the buyer.

In some embodiments, providing the detailed damage assessment of a vehicle includes providing vehicle information.

In some embodiments, providing vehicle information includes providing the year, make, and model of the vehicle.

In some embodiments, the maximum anticipated final lifetime mileage is based on the vehicle information.

In some embodiments, the fraudulent odometer mileage is the mileage of a rolled-back odometer, and wherein the mileage of the rolled-back odometer is less than the true mileage of the vehicle.

In some embodiments, the fraudulent odometer mileage is a mileage of a second odometer used to replace a first odometer of the vehicle, and wherein a mileage of the first odometer is greater than a mileage of the second odometer.

In some embodiments, the true mileage of the vehicle is a mileage of the vehicle at a time a seller purchased the vehicle.

In some embodiments, determining the total financial loss includes determining a repair cost of the vehicle after the time the buyer purchased the vehicle.

In some embodiments, determining the total financial loss comprises determining an anticipated resale value of the vehicle.

In some embodiments, the anticipated resale value of the vehicle is based on the anticipated remaining lifetime mileage of the vehicle.

In some embodiments, determining the anticipated resale value of the value is based on a True Mileage Unknown (TMU) loss of value.

In some embodiments, the TMU loss of value is based on a maximum loss of value, a first mitigation factor of vehicle age at the time of purchase, and a second mitigation factor of vehicle mileage at the time of purchase.

In some embodiments, the maximum loss of value is based on a percentage of the price of the vehicle paid by the buyer.

In some embodiments, prior to determining the dollar residual remaining usage value, a residual remaining usage value is determined.

In some embodiments, the residual remaining usage value is a percentage residual based on the anticipated remaining lifetime mileage at the time of purchase and the true remaining lifetime mileage at the time of purchase.

In some embodiments, the residual remaining usage value is zero.

In some embodiments, the dollar residual remaining usage value available at the time of purchase is zero.

In some embodiments, the total financial loss is the price of the vehicle paid by the buyer.

In some embodiments, the anticipated remaining lifetime mileage at the time of purchase is less than the anticipated remaining lifetime mileage at the time of purchase.

In some embodiments, the method further includes generating a report of the total financial loss.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the method and system of the disclosed subject matter. Together with the description, the drawings serve to explain the principles of the disclosed subject matter.

### BRIEF DESCRIPTION OF THE DRAWINGS

A detailed description of various aspects, features, and embodiments of the subject matter described herein is provided with reference to the accompanying drawings, which are briefly described below. The drawings are illustrative and are not necessarily drawn to scale, with some components and features being exaggerated for clarity. The drawings illustrate various aspects and features of the present subject matter and may illustrate one or more embodiment(s) or example(s) of the present subject matter in whole or in part.

FIG. 1 is a flow chart depicting a method for determining financial loss incurred from odometer fraud.

FIG. 2 is a table showing an analysis of financial loss incurred from odometer fraud for 47 vehicles.

FIG. 3 depicts a computing node according to embodiments of the disclosed subject matter.

### DETAILED DESCRIPTION OF AN EXEMPLARY EMBODIMENT

Reference will now be made in detail to exemplary embodiments of the disclosed subject matter, an example of which is illustrated in the accompanying drawings. The method and corresponding steps of the disclosed subject matter will be described in conjunction with the detailed description of the system.

The methods and systems presented herein may be used for identifying and determining the financial loss incurred by a buyer of a vehicle with a fraudulent odometer. The method and systems can be used by interested or affected parties (e.g., buyers of vehicles with odometer rollbacks), including but not limited to, government agencies when calculating financial loss for compensation as part of an odometer related action, by parties in civil legal actions, or for loss recovery claims settlements with insurers, as well as by other parties as appropriate. The disclosed subject matter also includes a computer program for identifying and determining the financial loss incurred by a buyer of a vehicle with a fraudulent odometer. Data values related to a vehicle can be provided as inputs to the computer program. Financial loss can be calculated and identified by applying a method provided herein.

A fraudulent odometer can include an odometer that is adjusted to display a lower mileage than the vehicle's actual or true mileage (e.g., a rolled-back odometer). A fraudulent odometer can include a physically or electronically altered odometer to change the recorded mileage of the vehicle. This may include replacement of the vehicle's original odometer, alteration of the internal mechanisms of the vehicle's original odometer, or hacking an electronic system of the odometer. A fraudulent odometer can include an odometer where the mileage is intentionally misrepresented or inaccurately documented (e.g., the mileage is misrepresented on an odometer disclosure statement) such that the vehicle's remaining service life or the vehicle's remaining usage is overestimated.

Reference is made herein to a “defrauded buyer” which includes a buyer of a vehicle who purchases a vehicle with a fraudulent odometer disclosure.

Vehicle lifetime and the service life of a vehicle can refer to the period of time during which a vehicle remains functional and operational (e.g., the vehicle's components and systems perform at or above expected levels of functionality and/or safety).

A buyer may rely upon the disclosed mileage of the vehicle to estimate the remaining useful vehicle life of a vehicle. Consumers may expect a vehicle's normal useful lifetime to be between 125,000 and 175,00 total miles. The vehicle's lifetime may be reduced as a result of an accident, natural disaster, negligent maintenance, theft or another event. Consequently, when a vehicle is presented to the consumer as being a low mileage vehicle (e.g., a vehicle between 7 and 10 years old with under 60,000 miles), that consumer may normally anticipate that the vehicle would have a long service life remaining (e.g., between 50,000 and 100,000 miles). When a vehicle is presented as having high mileage (e.g., a vehicle between 7 and 10 years old with over 80,000 to 100,000 miles), the consumer may anticipate that the vehicle has already used up most of its remaining useful life. In many cases, as high mileage vehicles approach or exceed their routine mileage lifetimes, they can start to fail safety or emissions tests. In addition, high mileage vehicles can start to experience cascading systems failures including brake failure, suspension, steering, and major driveline failures.

Odometer fraud can result in a financial harm to a consumer by providing misleading information about a vehicle's remaining service life. The nature of the financial harm caused by odometer fraud, as well as the method to determine the financial harm to the buyer, can depend upon specific characteristics of the vehicles (e.g., the vehicle's make, model, and year) and its anticipated use by the buyer.

Odometer fraud may not be discovered until the owner finds documents that indicate the vehicle's odometer mileage is not the true mileage, or the owner talks to prior owners, dealer service technicians, or other dealers who advise at the time of trading a vehicle in, that the odometer reading is incorrect. The discrepancy can be discovered when a dealership or a potential private buyer purchases a vehicle history report from companies such as CarFax or AutoCheck, or when checking with a public portal report retrieved from the National Motor Vehicle Title Information System (NMVTIS).

Database companies, such as CarFax and AutoCheck, collect motor vehicle titling information from state DMV agencies and other sources. This titling information is available to the public in the form of vehicle history reports. The titling information is also available to the public through the NMVTIS operated for USDOJ by American Association of Motor Vehicle Administrators (AAMVA). Vehicle history reports can show a historical trail of ownership, and titling and registration information such as dates of purchase, odometer readings, odometer warnings, “title brands,” and the title issuing state. Title “brands” such as “Odometer Discrepancy” or “Odometer not Actual” may be boldly printed on the vehicle history reports or disclosed in public NMVTIS reports.

Title brands can vary from state to state. However, all title brands can be detrimental to a vehicle's value. For vehicles with known odometer discrepancies, a state may issue a title with a brand stating “Warning—Odometer Discrepancy,” “Warning—Not Actual Mileage” or other words to the same effect. A “brand” on a vehicle's title is a warning sign for potential purchasers and can have an adverse effect on the vehicle's value.

Owners of vehicles with odometer discrepancies have limited methods in which to sell their vehicles. Traditional sale methods used by consumers to sell their vehicles include trading their vehicle for another vehicle to a franchise or used car dealership, selling the vehicle to an internet buying service, or selling it privately in person, via newspaper advertisement or over the internet. When a seller either transfers a title with an odometer discrepancy “brand” or the seller issues an odometer disclosure statement warning the purchaser that the vehicle's odometer cannot be relied upon, the seller may not receive the full value of the trade-in vehicle or the full value of the vehicle in a direct sale as compared to the sale of the same or similar vehicle that has the true and actual mileage.

In the used motor vehicle industry, dealers may not accept trade-in vehicles which have mileage discrepancy problems or odometer discrepancy “branded” titles. If the dealer accepts a vehicle in trade that has been disclosed as having an odometer discrepancy, the vehicle's trade-in value may be significantly reduced by the dealer in order to insulate that dealer from unanticipated losses on the resale of the trade-in vehicle.

Dealers often penalize individuals trading in vehicles with odometer discrepancies because it is difficult for the dealer to dispose of the vehicle and because the dealer cannot reliably estimate in advance the return upon resale. A legitimate dealer can have three basic ways to sell a vehicle with an odometer discrepancy. The dealer may attempt to sell the vehicle to the retail market with disclosure of the odometer discrepancy. The dealer may attempt to sell the vehicle to a wholesale dealer with disclosure of the odometer discrepancy. The dealer may attempt to sell the vehicle at a wholesale auction with disclosure of the odometer discrepancy.

Each selling method has inherent problems for a legitimately operating seller-dealer. Prospective buyers, whether dealers or retail customers, may refrain from knowingly purchasing a vehicle with an altered or incorrect mileage unless there is a significant decrease in price as compared to a vehicle with true and actual mileage.

Buyers may often rely heavily on the mileage indicated by the odometer as a key indicator for a vehicle's reliability, safety, condition, and performance. If the mileage is true and actual, absent a detailed inspection and diagnostic testing indicating to the contrary, buyers may interpret a high mileage vehicle as being less reliable and with less remaining useful life than a low mileage vehicle of the same kind. While a prospective buyer may not be able to reliably determine the prior maintenance service history or driving pattern of a vehicle, a prospective buyer may only evaluate the vehicle mileage when purchasing a used vehicle.

Mileage can also be a factor controlling several other aspects of the vehicle sales and support process. For example, financial lending institutions may not finance a vehicle with an odometer discrepancy. Manufacturers may deny warranty claims if an odometer discrepancy is discovered. A vehicle with an odometer discrepancy may not qualify to be sold by a franchise dealer as a “Certified Vehicle” because of the manufacturer's guidelines. Insurance companies may not pay full value on total loss settlements for such a vehicle because the value attributed to the vehicle will be diminished due to the fraudulent odometer.

It should be noted, while it may be difficult to determine the true mileage of a vehicle with a previously rolled-back odometer that has a branded title for odometer issues, the true mileage of a vehicle identified in the possession of an individual or dealer who has engaged in odometer tampering can be determined. When vehicles are identified in an odometer roll-back action, both the original true mileage and the rolled-back fraudulent mileage values can be determined. This can allow for a means of determining financial harm imposed by the fraudulent odometer to the defrauded buyer.

It should also be understood that it can be considered that evaluating the financial harm to a defrauded buyer from odometer rollbacks can depend on the subsequent life cycle of the compromised vehicle. In some cases, the defrauded buyer can be both a vehicle buyer and a seller of the vehicle. In other cases, they can be the last owner of the vehicle before it is permanently taken out of service. Each of these situations can create different modes of commerce, and the financial harm resulting from a fraudulent odometer (e.g., a rolled back odometer) can vary accordingly.

In the case of a buyer purchasing a newer model used vehicle with a rolled back odometer reading, and where the buyer is intending to keep the vehicle for only a number of years before reselling it, undetected odometer rollbacks may initially have no direct financial impact on the buyer. Odometer rollbacks can be made on newer model vehicles, which can make the mileage appear lower than the true mileage. The total mileage on newer model vehicles can be under 50,000 miles. In cases where vehicles come off lease after about two to four years, and there has been an odometer rollback, the odometer rollback can often be less than about 20,000 to 30,000 miles. Odometer rollbacks can be made in vehicles that have gone through multiple leases or ownership changes. For example, in vehicles coming off of a second lease or directly from a second owner.

If a buyer purchases such a vehicle and operates it for several years before reselling it, the undisclosed rollback mileage may go undetected. In this case, the original fraudulent seller benefits by misrepresenting the vehicle as a “low mileage car”, potentially inflating its price. Although the first buyer may not experience direct financial loss, the buyer may face higher repair costs and/or may experience failures faster than expected.

Financial harm on newer model rolled back vehicles can be calculated from the amount the buyer overpaid. However, the vehicle may still be an operable vehicle with a long remaining service life. If the original or a subsequent defrauded buyer tries to resell the vehicle, and the mileage rollback is discovered, they may suffer a financial loss due to a significant reduction in the resale value. The anticipated event and compensation for that anticipated loss can be included in the calculation of financial loss. It should also be noted that the longer the vehicle remains in service with the new owner, the less impact the mileage rollback can have on its resale or insurance claim value, as the residual damage from the rollback diminishes over time. The financial loss calculation can be made under the assumption that the fraudulent rollback seller of the vehicle is liable for compensating the defrauded buyer based upon the maximum expected loss to the defrauded buyer. This can include scenarios such as a prior sale of the vehicle, a prior accident, a prior unrecovered theft of the vehicle and/or a claims payout.

In the case of an odometer rollback on an older high mileage vehicle, the circumstances and impact of the fraud can differ significantly from those associated with newer model vehicles. In older high mileage vehicle, a fraudster may buy a high mileage older vehicle (e.g., a vehicle 10 years or older, or having greater than about 75,000 miles) and be able to roll back the mileage by many tens of thousands of miles. Older higher mileage vehicles can have actual mileages that are 75,000 miles or higher than was disclosed. They may be worn-out vehicles that were disposed of by their prior owners after repairs became more frequent or more expensive, and the vehicles were no longer economical to operate. Worn-out high mileage vehicles may be bought by predatory parties who roll back the odometers and resell them as much lower mileage older vehicles. Buyers of these vehicles may be looking for basic transportation to purchase and use as their critical transportation until the vehicles stop working or becomes too expensive to repair. In the case of worn-out high mileage vehicles, the odometer rollback fraud can misrepresent the remaining vehicle operating lifetime and defraud the buyer into purchasing a vehicle expecting to get years of basic service.

The financial harm from odometer fraud in the case of high mileage older vehicles can be attributed to the loss of anticipated usage expected by the buyer rather than from any diminished value on a subsequent resale of the vehicle. The financial loss can result from losing the years of expected service that the buyer is expectedly paying for and not receiving. A true disclosure of the odometer reading to the buyer, would likely deter the buyer from purchasing the vehicle, as the buyer would realize that the high mileage vehicle would not meet their functional needs as an operating vehicle. High mileage vehicles may be sold by owners at a low price, either through an auction, a trade-in on another vehicle, or the vehicle was repossessed by the selling dealer, and then resold to another buyer. Owners of high mileage vehicles may sell the vehicle when they determine that the vehicle is no longer reliable or economically serviceable. A buyer of the vehicle who intends to roll back the mileage, may be indifferent to the vehicle's condition, as the high mileage reduces the cost to the fraudster. This can allow the fraudster to purchase the vehicle at a lower price and perform a significant rollback of the mileage (e.g., a rollback of about 10,000 miles or more). Consequently, the fraudster may invest minimal capital while positioning themselves to achieve substantial profits. The fraudster may afford to overpay for the vehicle relative to a reseller, who reports the true mileage of the vehicle, because they can anticipate that rolling back the mileage may enable them to obtain inflated resale values compared to those achievable by a seller.

Financial harm to a defrauded buyer on a high mileage older vehicle with a rolled back odometer can be based upon the amount of an overpriced sale or even of the sale itself. Financial harm can be based on the sale itself because had the mileage been disclosed, the buyer may not have purchased the vehicle at all rather than buying it for a lower price. The financial loss from the odometer fraud may not simply be an across-the-board price adjustment. The financial loss from the odometer fraud can include a calculation of the impact of the fraudulent rollback on the expected remaining lifetime of the vehicle for the defrauded buyer. As an example, when a buyer and seller agree upon the sale price of the vehicle, both parties accept the price based on the assumption that the vehicle is accurately described (e.g., the true vehicle mileage is reported). Based on the information (e.g., the mileage) provided by the seller, the buyer forms expectations about the vehicle's remaining years of service life. The financial loss can be quantified based on the impact of the fraudulent odometer statement on the expected remaining lifetime of the vehicle. As an example, if the odometer declaration was for 125,000 miles, the buyer may have anticipated a remaining service life of 50,000 miles. If the odometer declaration was fraudulent, and the actual odometer reading was 170,000 miles, then that odometer rollback can overestimate the remaining service life of the vehicle by the amount of the rollback (i.e., the difference between the declared and true mileage). The impact would be that the vehicle would have approximately 5,000 remaining miles of service life instead of the anticipated 50,000 miles. In this example, this represents a defrauding of 90% of the remaining service life. If the buyer paid $5,000 for the vehicle, then they were defrauded out of 90% of the remaining service life they were anticipating to receive from the vehicle. The direct harm of the fraud would then be $4,500 out of the $5,000 that they paid. It should also be noted, that for resold high mileage vehicles with odometer rollbacks (unlike newer model vehicles with rolled back mileage), the final true mileage can be the actual mileage of the vehicle at the point when the prior owner determined the vehicle was no longer reliable or economically viable to repair. Resold high mileage vehicles are typically unsuitable for long term additional reliable use. In addition to the direct fraud, there are multiple additional financial harms from the purchase of the vehicle.

In addition to the immediate loss in value incurred when a purchaser unknowingly purchases a vehicle having an altered or “rolled-back” odometer, the owner can suffer multiple additional losses. These losses include: over-insuring the vehicle; paying sales taxes based upon the vehicles' inflated sales price; for vehicles that are registered in states having annual vehicle personal property taxes, paying higher annual personal property taxes based upon inflated vehicle valuations; paying unnecessary finance charges on the inflated sales price; incurring significant unscheduled maintenance and repair costs due to the undisclosed higher mileage; having a lower quality driving experience based upon having a vehicle which is more worn out than anticipated; having a vehicle with a remaining service life many years shorter in duration than the buyer expected; and in states with annual or periodic safety and emissions testing having state mandated major repairs in order to comply with state road use requirements. These additional losses can amount to many thousands of dollars, and in the case of older high mileage roll-back vehicles can exceed the original purchase price of the vehicle.

A detailed damage assessment can include vehicle information and sale information. Vehicle information can include the vehicle's Vehicle Identification Number and the year/make/model of the vehicle. Sale information can include the stated sale price, and the date of the sales transaction. The detailed damage assessment can include the declared mileage at the time of sale and an estimate of the true mileage at the time of sale. The title of the vehicle, transfer and sales documents can also be used to verify the vehicle information and the sale information.

Odometer fraud can occur when a seller deceives a buyer into believing that a vehicle has lower mileage and, consequently, a longer remaining service life than it actually does. This deception can be the result of rolling back the mileage on the vehicle odometer, but it can involve other means of deceiving. As an example, a seller may replace the instrument cluster with a different cluster showing a lower mileage, creating a similar fraudulent impact by misleading the buyer about vehicle's true mileage and condition. The seller may not update the mileage on the replaced odometer to reflect the vehicle's true mileage (or to reset it to zero miles indicating that it was replaced). Instead, the swap of the instrument cluster was conducted not as a repair but an attempt to obscure the true mileage from the defrauded buyer. The swap out of an instrument cluster to defraud the buyer may be similar fraud to a direct odometer rollback. In either case, the intent is to cause the buyer to believe that the mileage on the vehicle is less that the true mileage thereby allowing the fraudulent seller to cause the buyer to overvalue the condition and remaining service life of a vehicle. One can consider that an instrument cluster swap out undertaken when the existing cluster was already working is another form of an odometer rollback. Furthermore, if the seller knew of the prior mileage and (falsely) claims a true mileage unknown (TMU) status either explicitly or by omission of the prior known mileage that claim is being done with intent to defraud. In either case, the buyer has been led to misinterpret the remaining value of the vehicle, and one can closely estimate the most likely assumed existing mileage as the age of the vehicle at the time of the sales transaction times a normal standard annual mileage assumption on the part of the defrauded buyer. All damage calculations can reasonably flow using the inferred mileage in place of an explicit fraudulent mileage claim gotten from a rolled back odometer for purposes of a damage analysis.

The seller may either claim “True Mileage Unknown”, or make no mileage claim at all, leaving the buyer misled by omission. In that case, the claim of True Mileage Unknown may be a fraudulent misrepresentation in that the seller did know the true mileage when they purchased the vehicle. An investigator can determine the fraud by checking with the prior seller from whom the fraudulent acquired the vehicle from or by examining auction records for vehicles that were sold through an action. Auction records can disclose prior mileage and the condition of the odometer display at the time of sale. In cases where an instrument cluster replacement is used to mask the true mileage as a form of rollback, even if the selling party discloses “True Mileage Unknown” (TMU) to obscure their knowledge of the vehicle's prior mileage, it is still possible to estimate a reasonable expectation of the vehicle's mileage at the time of purchase. This estimate would be based upon the year model and age of the vehicle at the time of the purchase and normal assumptions of annual mileage of the vehicle at the time of the fraudulent transaction. This estimation can be also based on various factors, including historical records, maintenance logs, wear-and-tear indicators on the vehicle. A forensic analysis of the vehicle can also uncover information about the mileage rollback. Consequently, damage assessments for these transactions can be conducted in the same manner as for traditional odometer rollback fraud cases, utilizing similar investigative techniques and methodologies to determine the extent of the deception and its financial impact.

### Method of Use

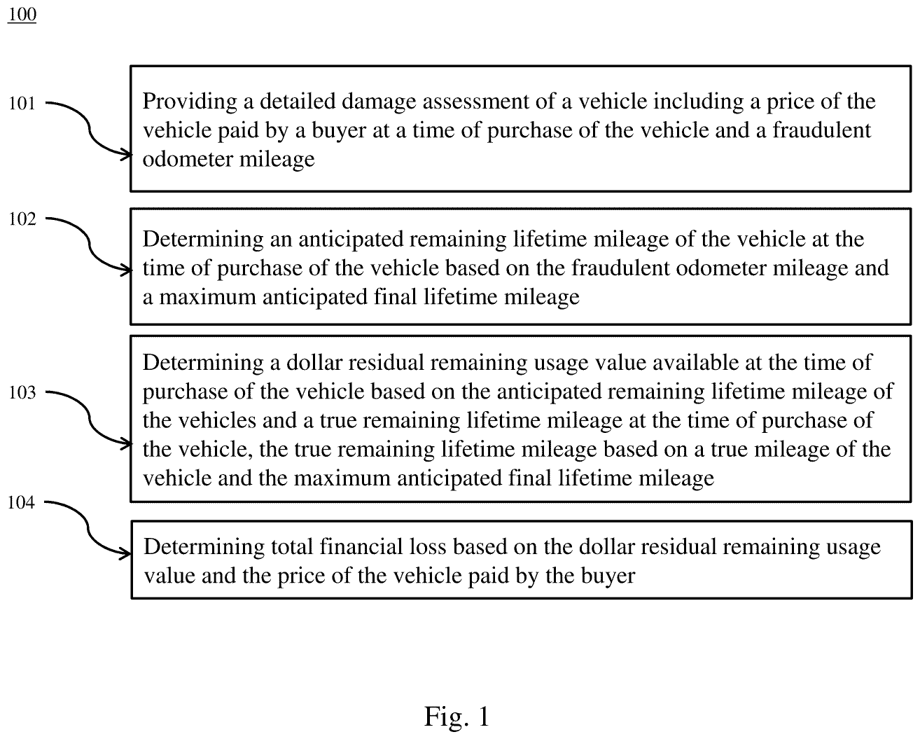

A method for identifying and computing financial loss incurred from odometer fraud is shown in FIG. 1. At step 101, a detailed damage assessment of a vehicle can be provided. The detailed damage assessment can include vehicle information and sale information. Vehicle information can include year, make, model, the vehicle's Vehicle Identification Number (VIN), and title date. Sale information can include the seller's vehicle purchase price, date of the purchase, the sale price paid by the defrauded buyer, and date of the sale. The detailed damage assessment can include the declared mileage at the time of transaction, the total true mileage or an estimate of the total true mileage at the time of transaction, the date of low mileage, low mileage, and minimum mileage removed. The low mileage data can refer to the date when the vehicle's odometer reading was lower than the mileage of the vehicle at the time of purchase by the seller. The low mileage can be the total mileage, as reported by a seller, at the time the vehicle is being resold by the party of interest. The minimum mileage removed can be the low mileage subtracted from the total true mileage or the estimate of the total true mileage at the time of purchase of the vehicle by the seller. The low mileage can be the rolled back disclosed mileage at the time of sale (e.g., resale of the vehicle by the seller) that the buyer assumes as the true mileage on the vehicle. The title of the vehicle, transfer and sales documents can also be used to verify the vehicle information and the sale information.

At step 102, an anticipated remaining lifetime mileage at the time of purchase is determined. The anticipated remaining lifetime mileage at the time of purchase can be estimated. The anticipated remaining lifetime mileage at the time of purchase can be the mileage of the fraudulent odometer (e.g., the rolled back odometer) at the time of purchase. The remaining lifetime mileage at the time of purchase can be determined by subtracting the fraudulent odometer mileage (e.g., the rolled back odometer) from the maximum anticipated final lifetime mileage for end-of-useful life as assumed by a typical buyer. The maximum anticipated final lifetime mileage for end-of-useful life can be the highest mileage a vehicle can reach by the time it is no longer operable, no longer economically viable, and/or no longer practical to use. The maximum anticipated final lifetime mileage for end-of-useful vehicle life can be based on factors such as typical usage patterns, vehicle make/model/year, and/or manufacturer expectations.

At step 103, the true remaining lifetime mileage at the time of purchase of the vehicle is determined. The true remaining lifetime mileage at the time of purchase can be estimated. A true mileage at the time of purchase can be the mileage of the vehicle at the time the seller purchased the vehicle, which can be the undisclosed mileage or the mileage prior to roll back of the odometer. The true remaining lifetime mileage at the time of purchase can be determined by subtracting the undisclosed true vehicle mileage at the time of purchase from the maximum anticipated final lifetime mileage for end-of-useful life.

At step 104, the residual remaining usage value available (to the defrauded buyer) at the time of vehicle purchase can be determined. The residual remaining usage value can be calculated as a ratio residual or a percentage residual based on the anticipated remaining lifetime mileage at the time of purchase and the true remaining lifetime mileage at the time of purchase. The percentage of residual remaining usage value can be zero when the true remaining lifetime mileage at the time of purchase is less than the zero. Determining the residual remaining usage value available to the defrauded buyer at the time of vehicle purchase can include calculating a dollar residual. The dollar residual remaining usage value available to the defrauded buyer at the time of vehicle purchase can be zero when the percentage of residual remaining usage value is zero. The dollar residual can be based on the purchase price paid by the defrauded buyer and the percentage residual. The dollar residual can be determined by multiplying the sale price of vehicle (the price of the vehicle to the defrauded buyer) by the percentage residual.

At step 105, the financial loss incurred by the defrauded buyer can be determined. Financial loss can be due to factors that affect the useful life of the vehicle or the residual value of the vehicle. Financial loss can be calculated by subtracting the dollar residual remaining true usage value from the purchase price paid by the defrauded buyer. Step 105 can further include determining financial loss for costs related to wear and usage repair costs resulting from a fraudulent odometer (e.g., undisclosed mileage, roll back mileage), which can be equivalent to the wear and usage repair costs. Available repair and/or service records can be used to identify repairs resulting from wear and tear usage. Repairs resulting from vehicle accidents may be included where warranty claims or insurance companies reduced coverage or payouts because of odometer fraud.

Financial loss can also be due to poor or undisclosed repairs which can incur additional repair costs and/or inspections for the buyer; the financial loss can be equivalent to the additional repair costs. Step 105 can further include determining financial loss related to vehicle branding (e.g., rebuilt title branding, salvage title branding, TMU branding) damages which can reduce the vehicle's value and/or usage. A salvage title can be issued to a vehicle that had significant damage and is considered unsafe or unsuitable for use. A rebuild title branding can be issued to a vehicle with a salvage title after it has been repaired and passes inspection. Vehicle branding damages can include damages due to undisclosed branding or misrepresented branding. Vehicle branding damages can include damages due to a branding of a vehicle after the time of purchase when odometer fraud is discovered. The financial loss related to vehicle branding damages may be based on the vehicle's reduced value and the expected or declared value of the vehicle at the time of purchase by the defrauded buyer. Step 105 can further include determining financial loss due to discovery a fraudulent odometer (e.g., rolled back odometer) resulting in a TMU branding, which can reduce the vehicle's value. Step 105 can further include determining financial loss due to undisclosed rebuilt vehicle status and/or salvage title branding. Financial loss can also include loss due to a determination of unsuitability for safe repair. Financial loss can also include loss due to reduced payout from an insurance claim as a result of reduced value of the vehicle. Financial loss can also include loss due to excess insurance premiums paid, and/or excess sales and personal property tax paid.

The financial loss incurred by the defrauded buyer may be a compensation to the defrauded buyer for reduced vehicle value for reduced usage of purchased vehicle lifetime and/or reduced value on the resale of the vehicle (e.g., vehicle resold or traded in before end of vehicle life). The maximum loss of value for resale can be based on TMU loss of value using a specified percentage of the sales price at the time of purchase by the degraded buyer. The calculation of maximum loss of value can be based on an adjusted mileage estimate rather than the TMU branding. This approach may better reflect the impact on future resale value. An adjusted maximum potential TMU impact based upon a mitigation factor of vehicle age at the time of purchase can be used to determine TMU loss of value. An adjusted maximum potential impact based upon a mitigation factor of vehicle mileage at the time of purchase can be used to determine TMU loss of value. A combined weighted TMU loss of value impact factor can be determine based on status of the vehicle at the time of purchase by the defrauded buyer. The maximum loss of value can be multiplied by the average of the mitigation factor of vehicle age and vehicle mileage at the time of purchase to calculate the combined weighted TMU loss of value.

The information of 47 vehicles was provided by National Highway Traffic Safety Administration (NHTSA). The 47 vehicles had a total reported dealer purchase price of $180,299. Using the provided vehicle information, it was determined whether a vehicle should be evaluated for purposes of odometer fraud losses as a vehicle likely purchased by a buyer for intermediate use, or as a vehicle that would be expected to be used by the buyer intended for its remaining service life. In the group of vehicles provided, primarily all but a single Ford Mustang with a VIN 1ZVBP8FF2E5301827 was unlikely to have been purchased with any expectation of future resale to another buyer. For purposes of financial harm analysis, the methodology used treated that vehicle as being operated over its full intended service life so that any loss of value in a subsequent resale was ignored. As a result, the damage estimate that would have occurred on a resale of the Mustang was not included. Consequently, if there were a resale of the vehicle by the defrauded buyer the analysis of financial harm would be understated.

As a group, the 47 vehicles were approximately 13.4 years old at the time they were purchased by Forrest Auto. The average true mileage on this total group of vehicles were 221,359 miles, and the average represented mileage after being rolled back was 121,817 miles. For 3 of the vehicles, the age of the vehicle at the time it was acquired for resale was computed. Based upon these particular vehicles which had an average of 13.4 years of age at the time of resale, using the rolled back mileage of these vehicles at the time of sale, the computed average annual mileage for this group of vehicles would have appeared to have averaged 9,923 miles driven per year. Using the true mileage for these vehicles, the average miles per year were 14,218 miles per year. Overall, for the total number of vehicles, the average reduction in disclosed mileage as a result of the roll back efforts by the enterprise was 51,968 miles. Based upon the average age of vehicles at the time they were acquired for resale, this represented an average theft of remaining drivable mileage of 5.6 years of hidden prior vehicle usage based upon that represented average historical usage of 8,508 miles per year.

For all of the vehicles, it was assumed that the rolled back disclosed mileage at the time of sale was the mileage that the buyer accepted as the true mileage on the vehicle at the time they made the purchase decision. The disclosed mileage was used as the basis for determining the buyer's expectation of the remaining service life of that vehicle. As a combined group average, the rolled back mileage on the vehicles provided the appearance of an average remaining unused mileage on the average vehicle of 5.6 miles. However, after adjusting for the true mileage on the vehicles as a group, the average remaining residual drivable mileage for this combined group of vehicles was −10,379 miles.

It must be noted that this is an across-the-board average, and for true analysis each vehicle needs to be calculated individually as was done for the detailed damage analysis. Since each individual purchaser will have their own intended usage patterns the actual remaining rate of mileage usage can vary, however, the fundamental reason for the purchase of the vehicle is for use, and the rolled back mileage determined for the purchased vehicle can be the basis for the fraudulent loss value that each buyer suffered as a result of the fraudulent representation by the seller. If an individual vehicle was calculated to have a negative residual useful remaining life, the useful productive remaining life was treated as being 0 miles. Consequently, if the average useful remaining life were determined to be negative, that still allowed for some vehicles to have a remaining life as would be the reality with a vehicle population. It should also be noted that a vehicle with 0 miles of remaining useful life may not mean that a vehicle cannot be used. It may mean that operating said vehicle is uneconomical and that on average such a vehicle would cost more to continue repairing than it would be to replace.

The ratio of rolled back mileage to the expected remaining mileage at the time of purchase was then used to arrive at a percentage of defrauded usage anticipation at the time of the sale. The percentage of defrauded usage anticipation at the time of the sale was the percentage loss in remaining useful life anticipated by the buyer at the time of purchase. The basic damage on each vehicle was the percentage of total anticipated mileage that was already consumed as a result of the mileage rollback multiplied by the declared purchase price paid for the vehicle.

The “loss of lifetime use” damage calculation for financial harm was based upon loss of expected mileage. This calculation did not factor in any loss based upon the quality of the remaining useful life of the vehicle. As an example, a vehicle with 100,000 miles can have a different quality of ride than the same vehicle after 175,000 miles.

For the group of vehicles in this analysis, the total miles removed via odometer rollback was −10,379 miles, and the defrauded value based upon the impact of the undisclosed mileage to the buyers was calculated as 2,494,462.

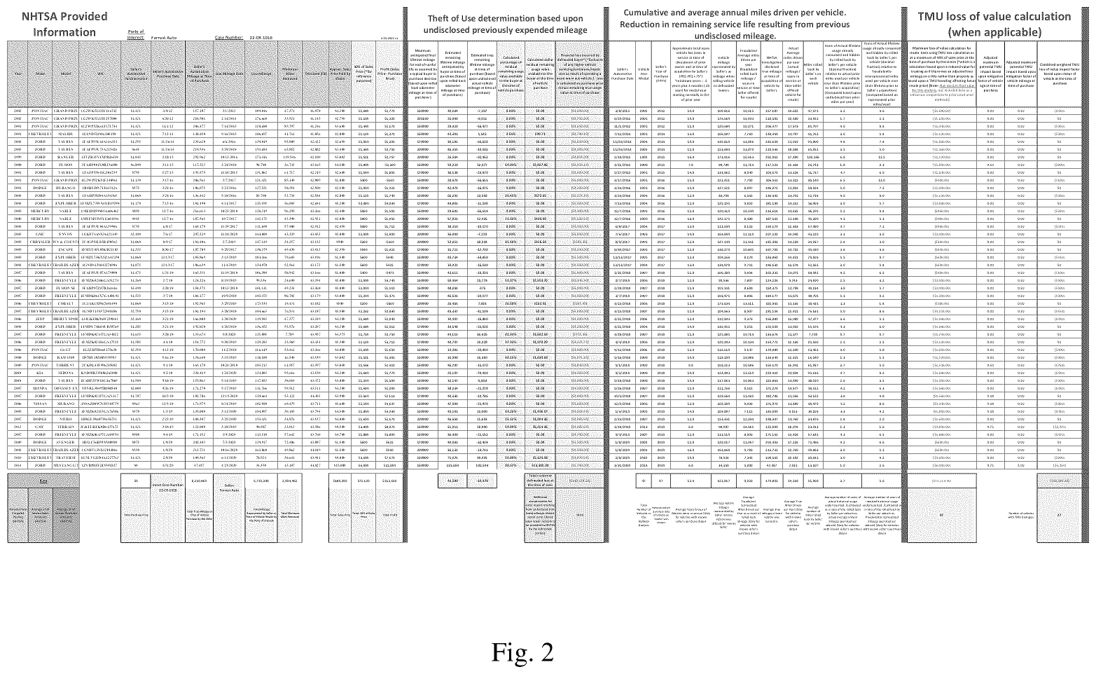

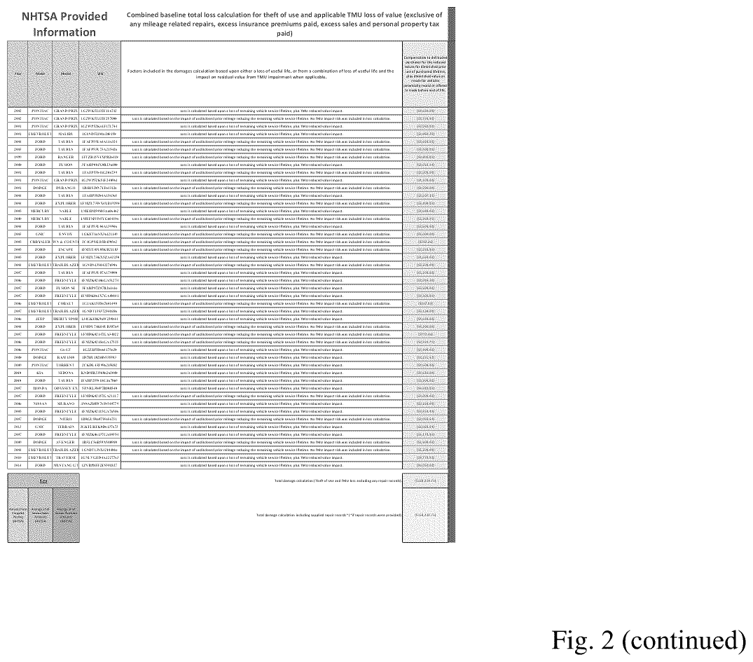

In addition to the calculation for lost lifetime usage of the vehicle due to odometer fraud, buyers may have experienced increased wear and usage repair costs on these vehicles as a result of the previous undisclosed mileage on these vehicles. Available repair records were used to identify repairs resulting from wear and tear usage which were included as an additional financial harm directly resulting from the unexpected costs by odometer fraud. Repairs resulting from accidents may be included where warranty claims or insurance companies reduced coverage or payouts because of odometer fraud. In those cases, if additional repair, service, warranty and/or insurance claims documentation were provided, additional losses directly related to the rollback were identified. In this case, additional identified damaged provided was $0.00. Including any provided additional repair amounts, the total combined damages calculated for loss of use and repairs was $140,178.55. A vehicle-by-vehicle breakout and calculation is shown in FIG. 2 There can also be a different form of harm that results from the subsequent discovery of rolled back mileage. Specifically, a vehicle may be branded as ‘True Mileage Unknown’ (TMU) or ‘Not Actual Mileage’, which can be an additional impairment to the vehicle's value as an asset. There can be a valuation reduction for resale impairment for reduced resale value based on TMU impairment. This branding can compound the initial harm of the theft of use due to undisclosed additional mileage. Undisclosed rebuilt vehicle status can also result in harm when significant repairs or insurance total loss payouts are not disclosed by the seller to a defrauded buyer. The reduction in value due to branding impairment from undisclosed rebuilt status can be equivalent to the financial impairment caused by undisclosed by TMU branding. Consequently, the methodology to determine financial harm due to undisclosed TMU status is applied to assess financial harm due to branding impairment from undisclosed rebuilt status. In the case of an undisclosed prior rebuilt vehicle, the financial harm may extend beyond the impairment caused by the undisclosed rebuilt or salvage title branding. There can also be immediate direct financial harm due to poor or undisclosed repairs, which may result in an unsafe vehicle or require additional inspections and/or repairs. There can be financial harm due to undisclosed rollback excess mileage related repairs. The damage and repair costs, or a determination of unsuitability for safe repair, may be made on a case-by-case basis. This was not considered in the financial harm analysis. In addition to theft of use from rolled back undisclosed mileage, there can be diminished value due to undisclosed rebuilt/salvage branding and financial loss from lack of suitability for use or repair.

There can be financial harm from a rollback discovered in a vehicle without TMU branding. Additional harm can result if the vehicle is resold and the rolled-back mileage is discovered, which can impair the vehicle's resale value. Additional harm can result if an insurance company discovers the rolled-back mileage when an insurance claim is filed, which may result in a reduced payout due to the reduced value of the vehicle. Both of these types of losses can be readily estimated by considering them as provisions for potential damages, based on the vehicle's future history following the time of purchase. Since the fraud occurs at the time of purchase and there is no mechanism available to hold funds in reserve to compensate a defrauded buyer for potential diminution in value at resale or at the time of a claim payout, this potential additional loss needs can be accounted for in the calculation of financial harm. This damage calculation may only be applicable for vehicles that are likely to have collision insurance coverage or are new vehicles, making them candidates for future resale to subsequent buyers by the current owner.

It should also be noted that the calculation of TMU type damages may decline over the life of the vehicle as it ages and as additional mileage is placed on the vehicle as it is in use. Consequently, the damage calculation may be based upon vehicle's status at the time of purchase. Other damages that result from an undisclosed TMU branding condition may exist and were not included in the calculation of damages. These damages can include high premiums associated with excess insurance coverage, which are based on a vehicle's assumed value. This value can be reduced in a claims payout if the insurer discovers the rolled back mileage, resulting in a lower assessed value during the claims appraisal process. Other uncompensated financial harm to the defrauded buyer can result from higher state sales tax or higher personal property tax payments where applicable which may be tied to an inflated value assigned to the vehicle. Other than insurance loss adjustments and impact on resale values, these other secondary TMU impacts were not included in the analysis.

For this group of vehicles the additional financial harm from TMU branding was computed to be $18,046.20. There were 27 vehicles determined to have some additional level of potential financial harm from the discovery of rolled back mileage resulting in either a TMU branding or otherwise uncovered by insurers or subsequent buyers if these vehicles resold or subject to insurance claims. When combined with the financial harm from reduced anticipated service calculation, the total combined loss for the full group of 47 vehicles totaled $158,224.75.

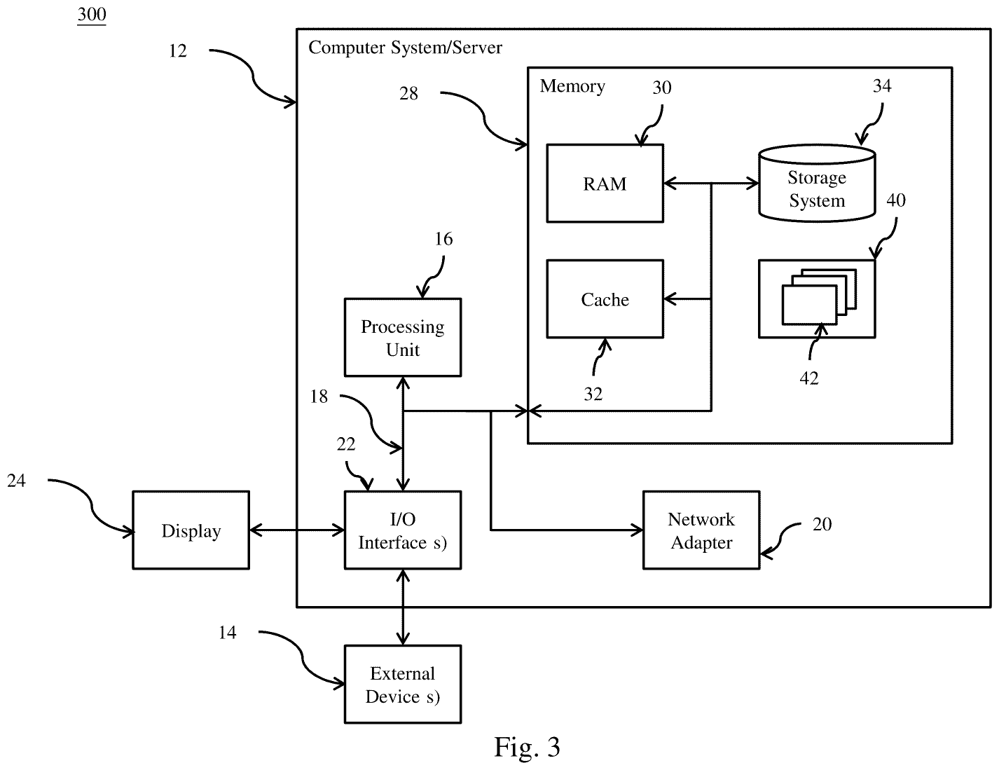

Referring now to FIG. 3, a schematic of an example of a computing node is shown. Computing node 300 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16. Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media. System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The disclosed subject matter may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s).

In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the disclosed subject matter is described herein in terms of certain preferred embodiments, those skilled in the art will recognize that various modifications and improvements may be made to the disclosed subject matter without departing from the scope thereof. Moreover, although individual features of one embodiment of the disclosed subject matter may be discussed herein or shown in the drawings of the one embodiment and not in other embodiments, it should be apparent that individual features of one embodiment may be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

1. A non-transitory computer readable medium with instructions stored thereon, that when executed by a processor, perform the steps of:
providing a detailed damage assessment of a vehicle including a price of the vehicle paid by a buyer at a time of purchase of the vehicle and a fraudulent odometer mileage;
determining an anticipated remaining lifetime mileage of the vehicle at the time of purchase of the vehicle based on the fraudulent odometer mileage and a maximum anticipated final lifetime mileage;
determining a dollar residual remaining usage value available at the time of purchase of the vehicle based on the anticipated remaining lifetime mileage of the vehicles and a true remaining lifetime mileage at the time of purchase of the vehicle, the true remaining lifetime mileage based on a true mileage of the vehicle and the maximum anticipated final lifetime mileage; and
determining total financial loss based on the dollar residual remaining usage value and the price of the vehicle paid by the buyer.

2. The non-transitory computer readable medium of claim 1, wherein providing the detailed damage assessment of a vehicle includes providing vehicle information.

3. The non-transitory computer readable medium of claim 2, wherein providing vehicle information includes providing the year, make, and model of the vehicle.

4. The non-transitory computer readable medium of claim 2, wherein the maximum anticipated final lifetime mileage is based on the vehicle information.

5. The non-transitory computer readable medium of claim 1, wherein the fraudulent odometer mileage is the mileage of a rolled-back odometer, and wherein the mileage of the rolled-back odometer is less than the true mileage of the vehicle.

6. The non-transitory computer readable medium of claim 1, wherein the fraudulent odometer mileage is a mileage of a second odometer used to replace a first odometer of the vehicle, and wherein a mileage of the first odometer is greater than a mileage of the second odometer.

7. The non-transitory computer readable medium of claim 1, wherein the true mileage of the vehicle is a mileage of the vehicle at a time a seller purchased the vehicle.

8. The non-transitory computer readable medium of claim 1, wherein determining the total financial loss includes determining a repair cost of the vehicle after the time the buyer purchased the vehicle.

9. The non-transitory computer readable medium of claim 1, wherein determining the total financial loss comprises determining an anticipated resale value of the vehicle.

10. The non-transitory computer readable medium of claim 9, wherein the anticipated resale value of the vehicle is based on the anticipated remaining lifetime mileage of the vehicle.

11. The non-transitory computer readable medium of claim 9, wherein determining the anticipated resale value of the value is based on a True Mileage Unknown (TMU) loss of value.

12. The non-transitory computer readable medium of claim 11, wherein the TMU loss of value is based on a maximum loss of value, a first mitigation factor of vehicle age at the time of purchase, and a second mitigation factor of vehicle mileage at the time of purchase.

13. The non-transitory computer readable medium of claim 12, wherein the maximum loss of value is based on a percentage of the price of the vehicle paid by the buyer.

14. The non-transitory computer readable medium of claim 1, wherein prior to determining the dollar residual remaining usage value, a residual remaining usage value is determined.

15. The non-transitory computer readable medium of claim 1, wherein the residual remaining usage value is a percentage residual based on the anticipated remaining lifetime mileage at the time of purchase and the true remaining lifetime mileage at the time of purchase.

16. The non-transitory computer readable medium of claim 14, wherein the residual remaining usage value is zero.

17. The non-transitory computer readable medium of claim 1, wherein the dollar residual remaining usage value available at the time of purchase is zero.

18. The non-transitory computer readable medium of claim 17, wherein the total financial loss is the price of the vehicle paid by the buyer.

19. The non-transitory computer readable medium of claim 1, wherein the anticipated remaining lifetime mileage at the time of purchase is less than the anticipated remaining lifetime mileage at the time of purchase.

20. The non-transitory computer readable medium of claim 1, further comprising generating a report of the total financial loss.
